(19) United States
(12) Patent Application Publication
(10) Pub. No.: US 2021/0390566 A1
(43) Pub. Date: Dec. 16, 2021

(54) ELECTRONIC DEVICE AND CONTROL METHOD THEREOF

(71) Applicant: SAMSUNG ELECTRONICS CO., LTD., Suwon-si (KR)

(72) Inventors: Jaemoon LIM, Suwon-si (KR); Hyunsik JUNG, Suwon-si (KR); Wonkeun OH, Suwon-si (KR); Suho LEE, Suwon-si (KR); Yeji HEO, Suwon-si (KR); Laura KANG, Suwon-si (KR); Seunghan GO, Suwon-si (KR)

(73) Assignee: SAMSUNG ELECTRONICS CO., LTD., Suwon-si (KR)

(21) Appl. No.: 17/332,447

(22) Filed: May 27, 2021

(30) Foreign Application Priority Data
Jun. 11, 2020 (KR) 10-2020-0070999

(51) Int. Cl. G06Q 30/02; G06Q 10/08

(52) U.S. Cl. CPC G06Q 30/0202; G06Q 10/087

(57) ABSTRACT

A control method of an electronic device includes obtaining first demand information related to a service demand of a prediction target item at a first time point, the first time point being after a Last-time Buy (LTB) point of the prediction target item; obtaining inventory information on the prediction target item at the first time point; identifying at least one similar item based on a comparison between service demand characteristics of the at least one similar item and service demand characteristics of the prediction target item; obtaining similar item information related to a service demand of the identified at least one similar item; obtaining demand forecast information after the first time point on the prediction target item based on the first demand information and the similar item information; and identifying whether an abnormal state has occurred at the first time point by comparing the demand forecast information after the first time point and the inventory information.

### CROSS-REFERENCE TO RELATED APPLICATION

This application is based on and claims priority under 35 U.S.C. § 119 to Korean Patent Application No. 10-2020-0070999, filed on Jun. 11, 2020, in the Korean Intellectual Property Office, the disclosure of which is incorporated by reference herein in its entirety.

### BACKGROUND

### 1. Field

The disclosure relates to an electronic device and a control method thereof, and more particularly to an electronic device capable of detecting in real-time abnormalities in inventory of a prediction target item and a control method thereof.

### 2. Description of Related Art

In a commercial transaction process between a finished product manufacturing company and a component producing company, the finished product manufacturing company generally identifies a quantity on a required item and then places an order for the corresponding quantity to the component producing company that manufactures the corresponding product.

Although the finished product manufacturing company may be able to maintain a balance of supply and demand of necessary materials during a contract period with the component producing company for supplying materials, there may be problems in maintaining constant additional supply and demand of the same items due to change in production facilities of the component producing company when the contract period is terminated (e.g., Last-Time Buy, LTB).

Accordingly, the finished product manufacturing company has to predict the total amount of service demand with respect to a prediction target item after the LTB point by utilizing data related to the finished product manufacturing company and the various prediction target items that the component producing company had in retention, and retain the prediction target item from the component producing company according to the forecast information at the LTB point.

If the total amount of the actual service demand after the LTB point with respect to the prediction target item is different from the total amount in forecasted service demand, there may be the problem of additional costs related to the prediction target item being generated.

In addition, by utilizing only the data related to the prediction target item and forecasting the total amount in service demand with respect to the prediction target item after the LTB point, there is also the problem of the accuracy decreasing.

### SUMMARY

Provided is an electronic device capable of forecasting a demand on a prediction target item by utilizing similar items having similar service demand characteristics as a prediction target item, and forecasting a demand of the prediction target item after a Last-time Buy (LTB) point of the prediction target item to detect in real-time abnormalities in inventory with respect to the prediction target item, and a control method thereof.

According to an aspect of the disclosure, a control method of an electronic device may include obtaining first demand information related to a service demand of a prediction target item at a first time point, the first time point being after a Last-time Buy (LTB) point of the prediction target item; obtaining inventory information on the prediction target item at the first time point; identifying at least one similar item based on a comparison between service demand characteristics of the at least one similar item and service demand characteristics of the prediction target item; obtaining similar item information related to a service demand of the identified at least one similar item; obtaining demand forecast information after the first point on the prediction target item based on the first demand information and the similar item information; and identifying whether an abnormal state has occurred at the first point by comparing the demand forecast information after the first point and the inventory information.

The obtaining the demand forecast information may include generating a demand forecast model based on the similar item information; and obtaining the demand forecast information by inputting the first demand information into the generated demand forecast model.

The similar item information may include second demand information corresponding to a service demand of the at least one similar item at the first time point and demand information on the at least one similar item after the first time point.

The demand forecast model may include a decision tree model. Based on using the second demand information as an input variable, the decision tree model may be trained so that demand forecast information on the prediction target item is output as a dependent variable.

The at least one similar item may be identified through a K-means clustering model, and the at least one similar item may belong to a same cluster as the prediction target item in the K-means clustering model.

The identifying whether the abnormal state has occurred may include identifying, based on the demand forecast information after the first point and the inventory information being different by a pre-set value or more, that the abnormal state has occurred.

The method may further include identifying, based on identifying that the abnormal state has occurred at the first point, response information on the abnormal state; and transmitting the identified response information to an external electronic device.

The method may further include obtaining, based on identifying that the abnormal state has not occurred at the first time point, third demand information related to a service demand of the prediction target item at a second time point, the second point being after the first time point; obtaining inventory information of the prediction target item at the second time point; obtaining demand forecast information after the second time point on the prediction target item by using the third demand information and the similar item information; and identifying whether the abnormal state has occurred by comparing the demand forecast information after the second time point and inventory information on the prediction target item at the second time point.

The demand forecast model may include one from among an artificial neural network model, a logistic regression model, a support vector machine model, or a random forest and gradient boosting model.

The obtaining the inventory information may include receiving identification information on the prediction target item and information for demand forecasting of the prediction target item from an external electronic device; and identifying the first demand information based on the identification information on the prediction target item and information for demand forecasting of the prediction target item.

According to another aspect of the disclosure, an electronic device may include a memory comprising at least one instruction; and a processor configured to execute the at least one instruction to: obtain first demand information related to a service demand of a prediction target item at a first time point, the first time point being after a Last-time Buy (LTB) point of the prediction target item; obtain inventory information on the prediction target item at the first time point, identify at least one similar item based on a comparison between service demand characteristics of the at least one similar item and service demand characteristics of the prediction target item; obtain similar item information related to a service demand of the identified at least one similar item, obtain demand forecast information after the first time point on the prediction target item based on the first demand information and the similar item information, and identify whether an abnormal state has occurred at the first time point by comparing the demand forecast information after the first time point and the inventory information. The processor may be further configured to generate a demand forecast model based on the similar item information, and obtain the demand forecast information by inputting the first demand information into the generated demand forecast model.

The similar item information comprises second demand information corresponding to a service demand of the at least one similar item at the first time point and demand information on the at least one similar item after the first time point. The demand forecast model may include a decision tree model. Based on using the second demand information as an input variable, the decision tree model may be trained so that demand forecast information on the prediction target item is output as a dependent variable.

The at least one similar item may be identified through a K-means clustering model, and the at least one similar item may belong to a same cluster as the prediction target item in the K-means clustering model.

The processor may be further configured to identify, based on the demand forecast information after the first point and the inventory information being different by a pre-set value or more, that the abnormal state has occurred.

The processor may be further configured to identify, based on identifying that the abnormal state has occurred at the first point, response information on the abnormal state, and transmit the identified response information to an external electronic device.

The processor may be further configured to obtain, based on identifying that the abnormal state has not occurred at the first time point, third demand information related to a service demand of the prediction target item at a second time point, the second time point being after the first time point; obtain inventory information of the prediction target item at the second time point, obtain demand forecast information after the second time point on the prediction target item by using the third demand information and the similar item information, and identify whether the abnormal state has occurred by comparing demand forecast information after the second time point and inventory information on the prediction target item at the second time point. The demand forecast model may include one from among an artificial neural network model, a logistic regression model, a support vector machine model, or a random forest and gradient boosting model.

The electronic device may further include a communication interface comprising circuitry. The processor may be further configured to control the communication interface to receive identification information on the prediction target item and information for demand forecasting of the prediction target item from an external device, and identify the first demand information based on the identification information on the prediction target item and information for demand forecasting of the prediction target item.

### BRIEF DESCRIPTION OF THE DRAWINGS

The above and other aspects, features, and advantages of certain embodiments of the present disclosure will be more apparent from the following description, taken in conjunction with the accompanying drawings, in which:

FIG. 1 is a block diagram showing a configuration of an electronic device according to an embodiment;

FIG. 2 is a diagram showing a product production progress and a product service generation progress of a prediction target item according to an embodiment;

FIG. 3 is a diagram showing a K-means clustering model for obtaining a similar item with respect to a prediction target item according to an embodiment;

FIG. 4 is a diagram showing a demand forecast model for forecasting future demands on a prediction target item according to an embodiment;

FIG. 5 is a diagram showing a method of forecasting real-time demand of a prediction target item through a demand forecast unit and an abnormality detection unit according to an embodiment;

FIG. 6 is a diagram showing a method of obtaining forecast demand information after a LTB point of a prediction target item through a demand forecast unit according to an embodiment;

FIG. 7 is a diagram showing a method of detecting abnormal circumstances in inventory with respect to a prediction target item in real-time through an abnormality detection unit according to an embodiment;

FIG. 8 is a flowchart showing a control method of an electronic device according to an embodiment; and

FIG. 9 is a sequence diagram showing an interaction between a server, a manufacturer server, and a DB server according to an embodiment.

### DETAILED DESCRIPTION

Hereinafter, various embodiments will be described in detail with reference to the accompanying drawings. The embodiments disclosed in the specification may be variously changed. A specific embodiment may be illustrated in the drawing and described in detail in the detailed description. However, the specific embodiment disclosed in the accompanying drawing is merely for easy understanding of various embodiments. Accordingly, it should be understood that the technical spirit is not limited to the specific embodiment disclosed in the accompanying drawing, and all equivalents or alternatives included in the disclosed spirit and technical scope are included.

The terms used herein are merely used to describe a specific embodiment, and are not intended to limit the scope of the disclosure. A singular expression includes a plural expression, unless otherwise specified.

In the disclosure, expressions such as “comprise,” “may comprise,” “include,” “may include,” or the like are used to designate a presence of a corresponding characteristic (e.g., elements such as numerical value, function, operation, or component, etc.), and not to preclude a presence or a possibility of additional characteristics.

In the disclosure, expressions such as “A or B,” “at least one from among A and/or B,” or “one or more of A and/or B” may include all possible combinations of the items listed together. For example, “A or B,” “at least one from among A and B,” or “at least one from among A or B” may refer to all cases including (1) at least one from among A, (2) at least one from among B, or (3) both of at least one from among A and at least one from among B.

Expressions such as “first”, “second”, and so on used herein may be used to refer to various elements regardless of order and/or importance. Further, it should be noted that the expressions are merely used to distinguish an element from another element and not to limit the relevant elements.

When a certain element (e.g., first element) is indicated as being “(operatively or communicatively) coupled with/to” or “connected to” another element (e.g., second element), it may be understood as the certain element being directly coupled with/to the other element or as being coupled through another element (e.g., third element).

On the other hand, when a certain element (e.g., first element) is indicated as “directly coupled with/to” or “directly connected to” another element (e.g., second element), it may be understood as another element (e.g., third element) not being present between the certain element and the other element.

The expression “configured to . . . (or set up to)” used in the disclosure may be used interchangeably with, for example, “suitable for . . . ,” “having the capacity to . . . ,” “designed to . . . ,” “adapted to . . . ,” “made to . . . ,” or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, the phrase “a processor configured to (or set up to) perform A, B, or C” may mean a dedicated processor for performing a corresponding operation (e.g., embedded processor), or a generic-purpose processor (e.g., a central processing unit (CPU) or an application processor) capable of performing the corresponding operations by executing one or more software programs stored in the memory device.

The terms “module” or “part” used in the embodiments perform at least one function or operation, and may be implemented as a hardware or software, or a combination of hardware and software. Further, a plurality of “modules” or a plurality of “parts”, except for a “module” or a “part” which needs to be implemented to a specific hardware, may be integrated to at least one module and implemented in at least one processor.

The various elements and areas in the drawings have been schematically illustrated. Accordingly, the technical spirit of the disclosure is not limited by the relative size or distance illustrated in the accompanied drawings.

In the description below, an electronic device may be implemented in various forms. The electronic device may be implemented in the form of a server, representatively, but is not limited thereto. The electronic device may be implemented as a display device such as a television (TV), or a mobile communication device such as a mobile phone, or the like, and may be implemented in various forms without limitation so long as it is a device including a memory, a processor, a communication interface, and the like.

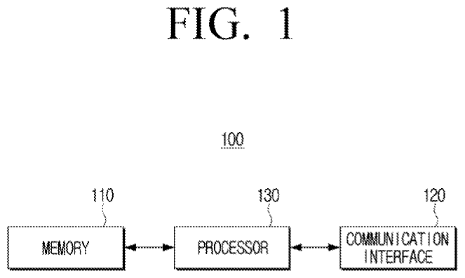

FIG. 1 is a block diagram showing a configuration of an electronic device according to an embodiment. In the embodiment below, an example of the electronic device implemented in the form of the server will be described in detail.

Referring to FIG. 1, the electronic device may be implemented in the form of a demand forecast server 100, and may include a memory 110, a communication interface 120, and a processor 130. The demand forecast server 100 (hereinafter, referred to as the electronic device) may be a server for forecasting a total amount of future service demands on a prediction target item.

The memory 110 may store at least one instruction on the electronic device 100. Further, the memory 110 may store an operating system (O/S) for driving the electronic device 100. In addition, the memory 110 may store various software programs or applications for operating the electronic device 100 according to one or more embodiments of the disclosure. Further, the memory 110 may include a semiconductor memory such as a flash memory, a magnetic storage medium such as a hard disk, or the like.

Specifically, the memory 110 may store various software modules for operating the electronic device 100 according to the one or more embodiments, and the processor 130 may be configured to control an operation of the electronic device 100 by executing the various software modules stored in the memory 110. That is, the memory 110 may be accessed by the processor 130 and reading/writing/modifying/deleting/updating of data by the processor 130 may be performed.

The term memory 110 used herein may be used as a meaning including the memory 110, a read only memory (ROM) in the processor 130, a random access memory (RAM) or a memory card (e.g., a micro secure digital (SD) card, a memory stick) mounted to the electronic device 100.

In an embodiment, the memory 110 may be configured to store information required in demand forecasting of the prediction target item. The prediction target item may be a material required in a finished product. For example, based on the finished product being a TV, the prediction target item with respect to the TV may be a display panel.

In an embodiment, the electronic device 100 may receive information required in demand forecasting of a plurality of items from the database (DB) server, and store the corresponding information in the memory 110. The DB server may be a server configured to receive information required in service demand forecasting of the plurality of items from the finished product manufacturing company and the component producing company, and store and manage the information.

The information required in demand forecasting may include master information, inventory information, production performance information, service performance information, and the like on the plurality of items, and include various information required in demand forecasting of other prediction target items.

In an embodiment, the memory 110 may be configured to store identification information on the prediction target item. In an embodiment, the electronic device 100 may receive identification information on the prediction target item from the manufacturer server, and store the information in the memory 110. The manufacturer server may be a server of the finished product manufacturing company, and the manufacturer server may be configured to send a request for requesting additional production of the prediction target item to the component producing company based on demand forecast information on the prediction target item from the electronic device 100 according to the disclosure.

The identification information on the prediction target item may be information for identifying the prediction target item, and in an embodiment, may include a material code for the prediction target item.

The communication interface 120 may be a configuration configured to perform communication with external devices of various types according to communication methods of various types. The communication interface 120 may include a Wi-Fi chip, a Bluetooth chip, a wireless communication chip, or an NFC chip. The processor 130 may be configured to perform communication with various external devices or servers using the communication interface 120. Specifically, the WiFi chip and the Bluetooth chip may be configured to perform communication through a WiFi method and a Bluetooth chip, respectively. When using the WiFi chip or the Bluetooth chip, various connection information such as a service set identifier (S SID) and a session key may first be transmitted and received, and may transmit and receive various information after communicatively coupling using the connection information. The wireless communication chip may refer to a chip performing communication according to various communication standards such as, for example, and without limitation, IEEE, ZigBee, 3rd generation (3G), 3rd generation partnership project (3GPP), long term evolution (LTE), or the like. The NFC chip may refer to a chip configured to operate in a near field communication (NFC) method using a 13.56 MHz band from among the various radio-frequency identification (RFID) frequency bands such as, for example, and without limitation, 135 kHz, 13.56 MHz, 433 MHz, 860-960 MHz, 2.45 GHz, or the like. Specifically, the communication interface 120 may be configured to perform communication an external electronic device, and the external electronic device according to an embodiment may include a manufacturer server and a DB server. In an embodiment, the communication interface 120 may be configured to receive identification information on the prediction target item from the manufacturer server. In addition, the communication interface 120 may be configured to receive information required in demand forecasting of the plurality of items and inventory information of the prediction target item from the DB server.

A function related to an artificial intelligence according to an embodiment may be operated through the processor 130 and the memory 110.

The processor 130 may include one or a plurality of processors. The one or plurality of processors may be a generic-purpose processor such as a central processing unit (CPU) or an application processor (AP), a graphics dedicated processor such as a graphics processing unit (GPU) or a vision processing unit (VPU), or an artificial intelligence dedicated processor such as a neural processing unit (NPU).

The one or plurality of processors may be configured to control so as to process input data according to a pre-defined operation rule or an artificial intelligence model stored in the memory 110. The pre-defined operation rule or the artificial intelligence model may be formed through learning.

The being created through learning may refer to a pre-defined operation rule or an artificial intelligence model of a desired characteristic being formed by applying a learning algorithm to multiple learning data. The learning may be carried out in the machine itself in which the artificial intelligence according to the disclosure is performed, or carried out through a separate server/system.

The artificial intelligence model may include a plurality of neural network layers. The respective layer may include a plurality of weight values, and perform processing of the layers through processing the processing results of a previous layer and the plurality of weight values. Examples of the neural network may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), and a Deep-Q Networks, and the neural network of the disclosure is not limited to the above-described examples, unless otherwise specified.

The learning algorithm may be a method for a predetermined target machine to make decisions or predictions on its own by using a plurality of learning data to train the predetermined target machine (e.g., robot). Examples of the learning algorithm may include supervised learning, unsupervised learning, semi-supervised learning, or reinforcement learning, and the learning algorithm of the disclosure is not limited to the above-described examples unless otherwise specified.

The processor 130 may be configured to control the overall operation of the electronic device 100. To this end, the processor 130 may include one or more from among a CPU, AP, or a communication processor (CP). The processor 130 may be implemented in various methods. For example, the processor 130 may be implemented using at least one from among an application specific integrated circuit (ASIC), an embedded processor, a microprocessor, a hardware control logic, a hardware finite state machine (FSM), and a digital signal processor (DSP). In the disclosure, the term processor 130 may be used as a meaning including a CPU, GPU, a main processing unit (MPU), and the like.

The processor 130 may be configured to run the operating system or an application program to control the hardware or software elements connected to the processor 130, and perform various data processing and calculations. In addition, the processor 130 may be configured to process instructions or data received from at least one from among the other elements by loading in a volatile memory, and store various data in a non-volatile memory.

The processor 130 according to an embodiment may be configured to obtain demand forecast information on the prediction target item after the Last-time Buy (LTB) point of the prediction target item. The demand forecast information after the LTB point refers to information on a total amount in service demand on the corresponding prediction target item required after the LTB point.

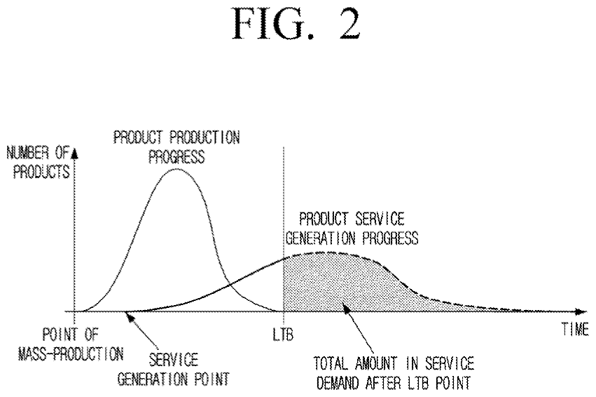

FIG. 2 is a diagram showing a product production progress and a product service generation progress of a prediction target item according to an embodiment. That is, referring to FIG. 2, the finished product manufacturing company may be able to maintain a balanced supply and demand on a required item within the contract period with the component producing company for supplying materials from the point of mass-production to the LTB point. However, it may be difficult to maintain a constant additional supply and demand on the corresponding item due to change in production facilities of the component producing company, when the contract period on the corresponding item is terminated (e.g., Last-Time Buy, LTB). Accordingly, the finished product manufacturing company may forecast the total amount in service demand on the prediction target item after the LTB point, and maintain a balanced supply and demand of the prediction target item provided by the component producing company according to the forecasted information at the LTB point.

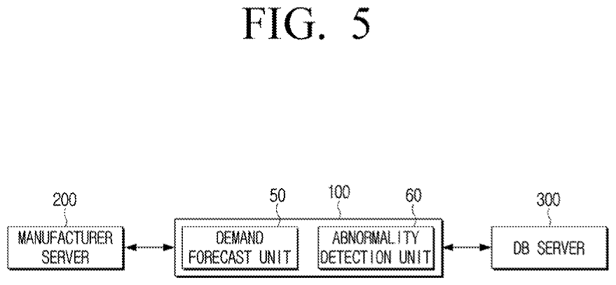

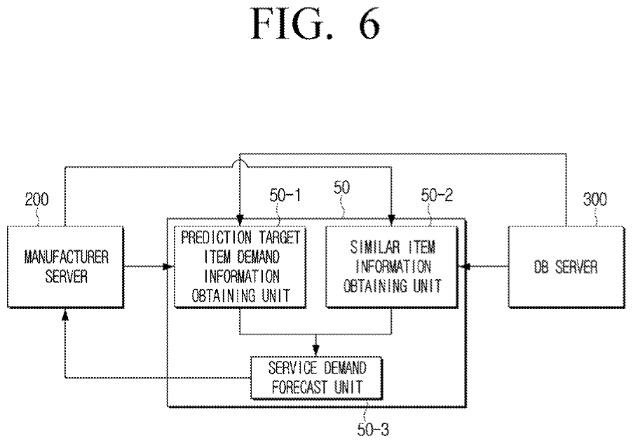

That is, when the electronic device 100 according to an embodiment transmits the demand forecast information after the LTB point of the prediction target item to the manufacturer server, which is the finished product manufacturing company server, the manufacturer server may send a request requesting additional production of the prediction target item, based on the received demand forecast information. In an embodiment, the processor 130 may be configured to obtain demand forecast information on the prediction target item after the LTB point through the demand forecast unit, and the detailed description thereof will be described through FIGS. 5 and 6.

According to an embodiment, the processor 130 may be configured to obtain demand forecast information on the prediction target item in real-time even after the LTB point of the prediction target item, and identify whether an abnormal state has occurred with respect to the prediction target item.

Specifically, the processor 130 may be configured to obtain first demand information related to (which has high relevance with) a service demand of the prediction target item at a first point after the LTB point of the prediction target item and inventory information on the prediction target item.

In an embodiment, the processor 130 may be configured to receive identification information on the prediction target item from the manufacturer server, and control the communication interface 120 to receive information required in demand forecasting of the plurality of items and inventory information of the prediction target item at the first point from the DB server. In an embodiment, the processor 130 may be configured to, based on identification information on the prediction target item, request information required in demand forecasting of the prediction target item from the DB server and control the communication interface 120 to receive the information required in demand forecasting of the prediction target item. However, the embodiment is not limited thereto, and the processor 130 may be configured to control the communication interface 120 to receive information required in demand forecasting of the plurality of items which include the prediction target item from the DB server, and use the identification information on the prediction target item to identify information required in demand forecasting of the prediction target item from a plurality of information.

The identification information on the prediction target item may be information for identifying the prediction target item, and in an embodiment, may include a material code for the prediction target item.

The information required in demand forecasting may include master information, inventory information, production performance information, service performance information, and the like on an item, and may include various information required in demand forecasting of other items.

The DB server may be a server configured to receive information required in service demand forecasting of the plurality of items from the finished product manufacturing company and the component producing company, and store and manage the information. In an embodiment, the DB server may be configured to receive inventory information, service performance information, and master information on the prediction target item from the finished product manufacturing company and store the information. In addition, the DB server may be configured to receive the inventory information on the prediction target item and the production performance information from the component producing company and store the information.

Then, the processor 130 may be configured to use information required in demand forecasting of the prediction target item from among the information required in service demand forecasting of the plurality of items, and obtain first demand information which has a high relevance with the service demand of the prediction target item at the first point after the LTB point of the prediction target item. The demand information may be information which has high relevance with the service demand of the item, and the first demand information of the prediction target item may include a production period of the prediction target item prior to the LTB point, a total amount in production with respect to the prediction target item, a service period, a total amount of service, a monthly production performance, a service performance zone, a defect generation rate, and the like, and may further include other, information which has high relevance with the demand information of the prediction target item.

Then, the processor 130 may be configured to identify at least one similar item corresponding to (which has similar) service demand characteristics of the prediction target item. Specifically, the processor 130 may be configured to use the information required in demand forecasting of the prediction target item and identify at least one similar item which is estimated to be similar in service demand characteristics with the prediction target item from among the plurality of items. In an embodiment, the processor 130 may be configured to identify at least one similar item through a K-means clustering model.

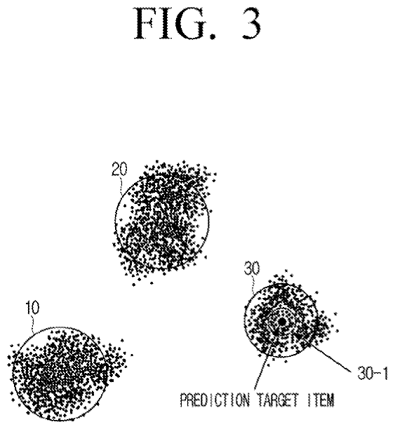

FIG. 3 is a diagram showing a K-means clustering model for obtaining a similar item with respect to a prediction target item according to an embodiment. As in FIG. 3, the K-means clustering model may be a model configured to classify data which are similar with one another to a same cluster and classify data which are not similar with one another to a different cluster, and may be used in identifying similar items, identifying similar search results, market analysis, and the like. In an embodiment, the K-means clustering model may be configured to classify data through a plurality of clusters, select a central value of the respective cluster, and show the correlation of the data on the respective central value and the data belonging to the corresponding cluster through a distance between the central value and the corresponding data.

That is, referring to FIG. 3, the processor 130 may be configured to classify the plurality of items into three clusters 10, 20 and 30 through the K-means clustering model. In an embodiment, the prediction target item may belong to a third cluster 30, and may be a central value of the third cluster 30. The processor 130 may be configured to identify the items belonging within an area 30-1 which is less than or equal to a pre-set distance from the central value of the third cluster 30 as similar items. Here, the pre-set distance may be changed according to a number of items belonging within the pre-set area 30-1. In an embodiment, the similar item to the prediction target item at the first point may be identified through information required in demand forecasting on the prediction target item at the LTB point of the prediction target item, but the embodiment is not limited thereto. That is, the similar items to the prediction target item at the first point may be identified through information required in demand forecasting on the prediction target item at the first point of the prediction target item. In the above-described embodiment, the similar items to the prediction target item have been described as being identified through the K-means clustering model, but the embodiment is not limited thereto. That is, the processor 130 may be configured so that the similar item to the prediction target item may be identified through a machine learning or a deep learning based various clustering techniques and similarity measurement model.

When at least one similar item is identified, the processor 130 may be configured to obtain similar item information related to the service demand of the identified at least one similar item. Specifically, the similar item information may include second demand information which has high relevance with the service demand of the similar item and actual demand information on the similar item. The second demand information may be information with high relevance with the service demand of the similar item, and may include a production period of the prediction target item prior to the LTB point, a total amount in production with respect to the similar item, a service period, a total amount of service, a monthly production performance, a service performance zone, a defect generation rate, and the like, and may further include other, information which has high relevance with the demand information of the similar item. The actual demand information on the similar item may be information on the total amount in the actual service demand on the similar item. In an embodiment, the actual demand on the similar item may include information on the actual total amount of service after the LTB point of the similar item.

When similar item information is obtained, the processor 130 may be configured to use the first demand information and the similar item information to obtain the demand forecast information after the first point on the prediction target item. The demand forecast information after the first point may be information on the total amount in service demand on the corresponding prediction target item required after the first point.

Specifically, the processor 130 may be configured to use the similar item information to generate the demand forecast model, input the first demand information to the generated demand forecast model, and obtain the demand forecast information after the first point on the prediction target item.

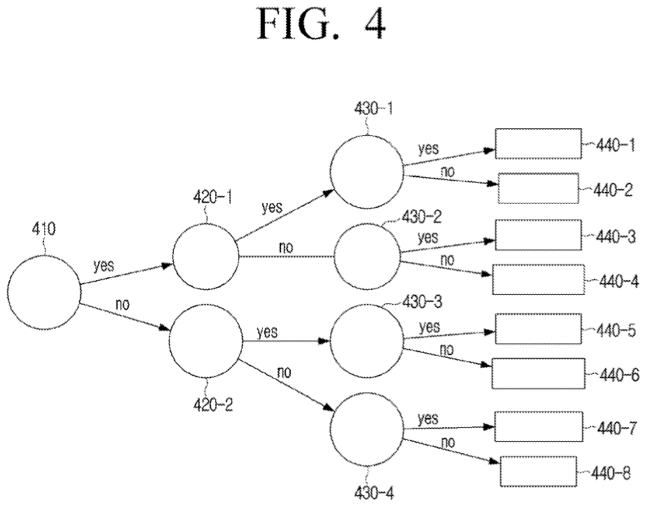

FIG. 4 is a diagram showing a demand forecast model for forecasting future demands on a prediction target item according to an embodiment. In an embodiment, the demand forecast model may be implemented through a decision tree model. The decision tree model may be a model generated by using the decision tree-based regression analysis technique, and may be a decision making support model which shows a decision making algorithm and the results thereof through a tree structure as in FIG. 4. Specifically, the decision tree model may be configured so that a second upper node 420-1 or 420-2 may be identified based on a YES or NO on a first upper node 410. That is, in the first upper node 410, when a certain condition value corresponding to the first upper node 410 is satisfied (YES) it may be moved to a second-1 upper node 420-1, and when a certain condition value corresponding to the first upper node 410 is not satisfied (NO) it may be moved to a second-2 upper node. In addition, a third upper node 430-1 to 430-4 may be identified as a result on a certain condition value corresponding to the respective second upper nodes 420-1 and 420-2 and lower nodes 440-1 to 440-8 which are the final result value may be identified as a result on a certain condition value corresponding to the respective third upper nodes 430-1 to 430-4. Although the upper nodes have been shown as three layers in FIG. 4, the embodiment is not limited thereto, and the number of the upper node layers may be changed according to the decision tree model.

In an embodiment, the processor 130 may be configured to set the second demand information which has a high relevance with the service demand of the similar item as an input variable and train the decision tree model so that demand forecast information on the prediction target item may be output as a dependent variable. In an embodiment, based on the similar item to the prediction target item being a first similar item, a second similar item and a third similar item, the second demand information may include second demand information on the first similar item, second demand information on the second similar item, and second demand information on the third similar item with respect to the prediction target item. Then, the second demand information on the first similar item, the second demand information on the second similar item, and the second demand information on the third similar item may be set as variables with respect to the first upper node to the third upper node, and the decision tree model may be trained so that the demand forecast information on the prediction target item may be output as a dependent variable. Then, the processor 130 may be configured to input first demand information on the prediction target item to the trained decision tree model, and obtain demand forecast information after the first point on the prediction target item.

In the above-described embodiment, similar items to the prediction target item being identified through the decision tree model have been described, but the embodiment is not limited thereto. That is, the processor 130 may be configured so that similar items to the prediction target item may be identified through the machine learning or deep learning based various forecast models. In an embodiment, the demand forecast model may be implemented as an artificial neural network model, a logistic regression model, a support vector machine model, a random forest and gradient boosting model, and the like.

Based on demand forecast information after the first point on the prediction target item being obtained, the processor 130 may be configured to compare demand forecast information after the first point on the prediction target item and inventory information on the prediction target item, and identify whether an abnormal state occurred.

In an embodiment, based on the demand forecast information after the first point on the prediction target item and the inventory information on the prediction target item being different by a pre-set value (e.g., 30%) or more, the processor 130 may be configured to identify that an abnormal state has occurred at the first point. The abnormal state may be classified into an over-forecasted state and an under-forecasted state. Specifically, the processor 130 may be configured to identify as an over-forecasted state when the demand forecast information after the first point on the prediction target item is greater than the inventory information on the prediction target item by a pre-set value or more. In addition, the processor 130 may be configured to identify as an under-forecasted state when the demand forecast information after the first point on the prediction target item is smaller than the inventory information on the prediction target item by a pre-set value or more.

Then, based on identifying that an abnormal state has occurred at the first point, the processor 130 may be configured to identify response information on the abnormal state. The response information on the over-forecasted state may include response information which may deplete the prediction target item at a low cost. For example, the response information on the over-forecasted state may include a request for terminating production of prediction target item, a request for transmitting and reviewing a list of compatible items, a request for transmitting and reviewing a list of companies capable of selling the prediction target item, and the like.

The response information on the under-forecasted state may include response information which may secure the prediction target item at a low cost. For example, the response information on the under-forecasted state may include a request for production rate improvement of the prediction target item, a request for transmitting and reviewing a list of compatible item materials, a request for production unit cost negotiation with the component producing company, and the like.

That is, the processor 130 may be configured to identify response information appropriate to the corresponding state from among the plurality of response information on the abnormal state when it is identified that an abnormal state has occurred at the first point, and control the communication interface 120 to transmit the identified response information to the manufacturer server.

Then, based on identifying that an abnormal state has not occurred at the first point, the processor 130 may be configured to identify whether the abnormal state on the prediction target item has occurred after the first point in real-time.

Specifically, based on identifying that an abnormal state has not occurred at the first point, the processor 130 may be configured to obtain third demand information which has high relevance with the service demand of the prediction target item at a second point after the first point and inventory information of the prediction target item, and use the third demand information and similar item information on the prediction target item to obtain demand forecast information after the second point on the prediction target item. The processor 130 may be configured to compare the demand forecast information after the second point and the inventory information on the prediction target item at the second point, and identify whether an abnormal state has occurred.

FIG. 5 is a diagram of forecasting real-time demand of a prediction target item through a demand forecast unit 50 and an abnormality detection unit 60 according to an embodiment.

Referring to FIG. 5, the electronic device 100 may receive identification information on the prediction target item from the manufacturer server 200. In an embodiment, the manufacturer server 200 may be a server of the finished product manufacturing company. The identification information on the prediction target item may be information for identifying the prediction target item, and in an embodiment, may include a material code for the prediction target item.

The electronic device 100 may receive information required in demand forecasting of the plurality of items from the DB server 300. In an embodiment, the DB server 300 may be a server configured to receive information required in service demand forecasting of the plurality of items including the prediction target item from the finished product manufacturing company and the component producing company, and store and manage the information. The information required in demand forecasting of an item may include master information, inventory information, production performance information, service performance information, and the like on an item, and include various information required in demand forecasting of other items.

Although the electronic device 100 has been described as receiving identification information on the prediction target item from the manufacturer server 200, and receiving information required in service demand forecasting of the plurality of target items from the DB server 300, the embodiment is not limited thereto. That is, the electronic device 100 may receive information (master information, inventory information, production performance information, service performance information, and the like of the prediction target item) required in demand forecasting of the prediction target item from the manufacturer server 200, and receive information (master information, inventory information, production performance information, service performance information, and the like, on the plurality of items different from the prediction target item) required in demand forecasting of the plurality of items different from the prediction target item from the DB server 300.

Based on the identification information on the prediction target item and the information required in demand forecasting being received, the electronic device 100 may obtain demand forecast information on the prediction target item after the LTB point and real-time demand forecast information after the LTB point through the demand forecast unit 50. Then, the electronic device 100 may transmit demand forecast information on the prediction target item after the LTB to the manufacturer server 200. The demand forecast unit 50 according to an embodiment will be described below through FIG. 6.

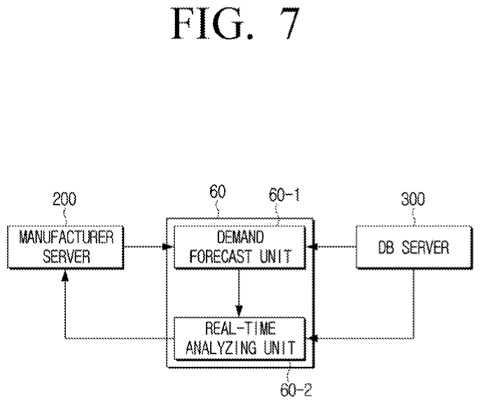

In addition, the electronic device 100 may identify whether an abnormal state has occurred on all target items required by the manufacturer server including the prediction target item through the abnormality detection unit 60. Then, when an abnormal state has occurred, the electronic device 100 may transmit response information corresponding to the abnormal state to the manufacturer server 200. The abnormality detection unit 60 according to an embodiment will be described below through FIG. 7.

FIG. 6 is a diagram showing a method of obtaining forecast demand information after a LTB point of a prediction target item through a demand forecast unit according to an embodiment.

According to an embodiment, the demand forecast unit 50 may forecast service demand on the prediction target item from the LTB point to after the LTB point of the prediction target item. Referring to FIG. 6, the demand forecast unit 50 may include a prediction target item demand information obtaining unit 50-1, a similar item information obtaining unit 50-2, and a service demand forecast unit 50-3.

The prediction target item demand information obtaining unit 50-1 may be a configuration for obtaining demand information which has high relevance with the service demand of the prediction target item. The demand information may be information which has high relevance with the service demand of the prediction target item, and may include a production period of the prediction target item prior to the LTB point, a total amount in production with respect to the prediction target item, a service period, a total amount of service, a monthly production performance, a service performance zone, a defect generation rate, and the like, and may further include other, information which has high relevance with the demand information of the prediction target item.

Specifically, the prediction target item demand information obtaining unit 50-1 may be configured to use identification information on the prediction target item to identify information required in demand forecasting of the prediction target item from among the information required in demand forecasting of the plurality of items received from the DB server 300. Then, the prediction target item demand information obtaining unit 50-1 may be configured to use information required in demand forecasting of the prediction target item to obtain demand information which has high relevance with the service demand of the prediction target item.

The similar item information obtaining unit 50-2 may identify items which has similar service demand characteristics with the prediction target item, and obtaining similar item information on the similar item.

Specifically, the similar item information obtaining unit 50-2 may be configured to use information required in demand forecasting of the plurality of items received form the DB server 300 and identification information on the prediction target item to identify at least one similar item which is estimated to be similar in service demand characteristics with the prediction target item. In an embodiment, the similar item information obtaining unit 50-2 may be configured to identify the similar item on the prediction target item through a machine learning or a deep learning based various clustering techniques and similarity measurement model, and for example, the similar item may be identified through the K-means clustering model.

Based on at least one similar item being identified, the similar item information obtaining unit 50-2 may be configured to use information required in demand forecasting of the plurality of items received from the DB server 300 to obtain similar item information on the identified at least one similar item. The similar item information may be information related to the service demand of the similar item, and may include demand information which has high relevance with the service demand of the similar item and actual demand information on the similar item.

The demand information which has high relevance with the service demand of the similar item may include a production period of the similar item prior to the LTB point, a total amount in production with respect to the similar item, a service period, a total amount of service, a monthly production performance, a service performance zone, a defect generation rate, and the like, and may further include other, information which has high relevance with the demand information of the similar item. The actual demand information on the similar item may be information on the total amount in actual service demand after the LTB point of the similar item.

The service demand forecast unit 50-3 may obtain demand forecast information of the prediction target item after the LTB point with respect to the prediction target item. The demand forecast information after the LTB point may refer to information on the total amount in service demand with respect to the corresponding prediction target item required after the LTB point.

Specifically, the service demand forecast unit 50-3 may be configured to use the demand information on the prediction target item and the similar item information on the at least one similar item to obtain demand forecast information on the prediction target item.

For example, the service demand forecast unit 50-3 may be configured to obtain demand forecast information through the demand forecast model. The demand forecast model may be implemented as the decision tree model, but the embodiment is not limited thereto, and the demand forecast model may be implemented as an artificial neural network model, a logistic regression model, a support vector machine model, a random forest and gradient boosting model, and the like.

Based on the demand forecast model being implemented as the decision tree model, the corresponding demand forecast model may generated by setting the demand information with a high relevance with the service demand of the similar item as an input variable, and setting the actual service demand information of the similar item as a dependent variable.

Then, based on the demand forecast information of the prediction target item after the LTB point on the prediction target item being obtained through the service demand forecast unit 50-3, the electronic device 100 may transmit the demand forecast information to the manufacturer server 200. Then, the manufacturer server 200 may be configured to request, based on the demand forecast information received from the electronic device 100, additional production of the forecasted prediction target item based on a total amount of in service demand to the component producing company.

FIG. 7 is a diagram showing a method of detecting abnormal circumstances in inventory with respect to a prediction target item in real-time through an abnormality detection unit according to an embodiment.

The electronic device 100 may detect an inventory abnormal state on the prediction target item through the abnormality detection unit 60 of FIG. 7 in real-time, and when an abnormal state is generated, transmit response information corresponding to the abnormal state to the manufacturer server 200.

Specifically, the abnormality detection unit 60 may include a demand forecast unit 60-1 and a real-time analyzing unit 60-2.

The demand forecast unit 60-1 may be a configuration for forecasting future service demands on the prediction target item, and may be the same configuration as with the demand forecast unit 50 of FIG. 6. However, although the demand forecast unit 50 of FIG. 6 may forecast the service demand on the future prediction target item at the LTB point of the prediction target item, the demand forecast unit 60-1 of FIG. 7 may forecast the real-time service demand on the prediction target item after the LTB point.

In addition, the demand forecast unit 60-1 of FIG. 7 may be configured to forecast not only the prediction target item which obtained the demand forecast information in the demand forecast unit 50 of FIG. 6, but also the future service demands on all items required in the finished product of the prediction target item.

In an embodiment, the demand forecast unit 60-1 may be configured to obtain first demand information which has high relevance with the service demand of the prediction target item at the first point after the LTB point of the prediction target item. In an embodiment, the demand forecast unit 60-1 may be configured to receive identification information on the prediction target item from the manufacturer server 200, and receive information required in demand forecasting of the plurality of items from the DB server 300.

Then, the demand forecast unit 60-1 may be configured to use the information required in demand forecasting of the prediction target item from among the information required in the service demand forecasting of the plurality of items to obtain first demand information which has high relevance with the service demand of the prediction target item at the first point after the LTB point of the prediction target item.

Then, the demand forecast unit 60-1 may be configured to identify at least one similar item which has similar service demand characteristics with the prediction target item. Specifically, the demand forecast unit 60-1 may be configured to use information required in demand forecasting of the prediction target item to identify at least one similar item which is estimated to be similar in service demand characteristics with the prediction target item from among the plurality of items.

Based on at least one similar item being identified, the demand forecast unit 60-1 may be configured to obtain similar item information related to the service demand of the identified at least one similar item. Specifically, the similar item information may include second demand information which has high relevance with the service demand of the similar item and the actual demand information on the similar item.

Based on the similar item information being obtained, the demand forecast unit 60-1 may be configured to use the first demand information and the similar item information to obtain demand forecast information after the first point on the prediction target item.

Based on the demand forecast information after the first point on the prediction target item being obtained through the demand forecast unit 60-1, the real-time analyzing unit 60-2 may be configured to compare demand forecast information after the first point on the prediction target item and inventory information on the prediction target item, and identify whether an abnormal state has occurred. Specifically, the real-time analyzing unit 60-2 may be configured to receive inventory information on the prediction target item from the DB server 300. The inventory information on the prediction target item may be inventory information on the prediction target item which is usable at a current point.

Then, based on the demand forecast information after the first point on the prediction target item and the inventory information on the prediction target item being different by a pre-set value (e.g., 30%) or more, real-time analyzing unit 60-2 may be configured to identify as an abnormal state having occurred at the first point. The abnormal state may be classified into an over-forecasted state and an under-forecasted state. Specifically, the real-time analyzing unit 60-2 may be configured to identify as an over-forecasted state when the demand forecast information after the first point on the prediction target item is greater than the inventory information on the prediction target item by a pre-set value or more. In addition, the real-time analyzing unit 60-2 may be configured to identify as an under-forecasted state when the demand forecast information after the first point on the prediction target item is smaller than the inventory information on the prediction target item by a pre-set value or more.

Then, based on identifying that an abnormal state has occurred at the first point, the real-time analyzing unit 60-2 may be configured to identify response information on the abnormal state. The response information on the over-forecasted state may include response information which may deplete the prediction target item at a low cost. For example, the response information on the over-forecasted state may include a request for terminating production of prediction target item, a request for transmitting and reviewing a list of compatible items, a request for transmitting and reviewing a list of companies capable of selling the prediction target item, and the like.

The response information on the under-forecasted state may include response information which may secure the prediction target item at a low cost. For example, the response information on the under-forecasted state may include a request for production rate improvement of the prediction target item, a request for transmitting and reviewing a list of compatible item materials, a request for production unit cost negotiation with the component producing company, and the like.

That is, the real-time analyzing unit 60-2 may be configured to identify response information appropriate to the corresponding state from among the response information on the abnormal state when it is identified that an abnormal state has occurred at the first point, and transmit the identified response information to the manufacturer server.

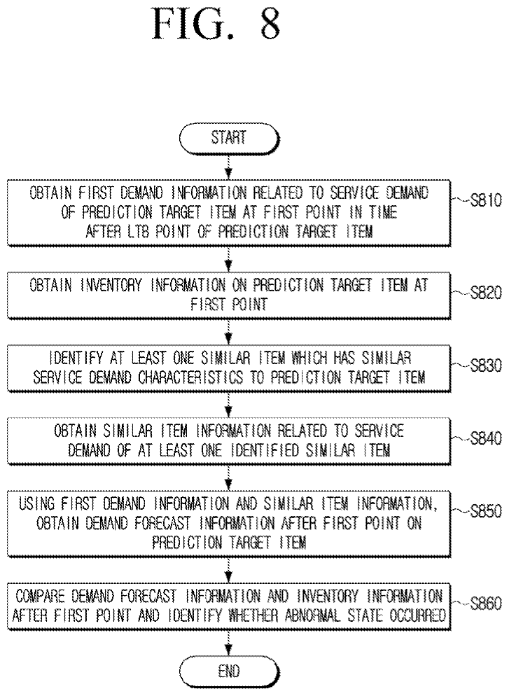

FIG. 8 is a flowchart showing a control method of a server according to an embodiment.

Referring to FIG. 8, the electronic device 100 may obtain first demand information which is related to (e.g., has high relevance with) the service demand of the prediction target item at the first point in time after the LTB point of the prediction target item (S810). The first demand information may be information which has high relevance with the service demand of the prediction target item, and may include a production period of the prediction target item prior to the LTB point, a total amount in production with respect to the prediction target item, a service period, a total amount of service, a monthly production performance, a service performance zone, a defect generation rate, and the like, and may further include other, information which has high relevance with the demand information of the similar item.

In an embodiment, the electronic device 100 may receive identification information on the prediction target item from a second server, receive information required in demand forecasting of the prediction target item from the DB server, use the information required in demand forecasting of the prediction target item and the identification information on the prediction target item to obtain the first demand information.

Then, the electronic device 100 may obtain inventory information on the prediction target item at the first point (S820). For example, the electronic device 100 may receive information on the total amount of inventory of the prediction target item that currently remain at the first point from the manufacturer server 200 or the DB server 300.

Then, the electronic device 100 may identify at least one similar item which has similar service demand characteristics to the prediction target item (S830). Specifically, the electronic device 100 may use the information required in demand forecasting of the prediction target item to identify at least one similar item which is estimated to be similar in service demand characteristics with the prediction target item from among the plurality of items. In an embodiment, the processor 130 may be configured to identify the at least one similar item through the K-means clustering model.

Based on the similar item being identified, the electronic device 100 may obtain similar item information related to the service demand of the identified at least one similar item (S840). The similar item information may include the second demand information which has a high relevance with the service demand of the similar item and the actual demand information on the similar item.

Based on similar information being obtained, the electronic device 100 may use the first demand information and the similar item information to obtain demand forecast information after the first point on the prediction target item (S850). The demand forecast information after the first point may be information on the total amount of service demand on the corresponding prediction target item required after the first point. Specifically, the electronic device 100 may use the similar item information to generate the demand forecast model, and input first demand information to the generated demand forecast model to obtain demand forecast information after the first point on the prediction target item.

Based on demand forecast information after the first point being obtained, the electronic device 100 may compare the demand forecast information after the first point and the inventory information of the prediction target item at the first point to identify whether an abnormal state has occurred (S860). In an embodiment, based on the demand forecast information after the first point on the prediction target item and the inventory information on the prediction target item being different by a pre-set value or more, the electronic device 100 may identify that an abnormal state has occurred at the first point. The abnormal state may be classified into an over-forecasted state and an under-forecasted state. Specifically, the electronic device 100 may identify as an over-forecasted state when the demand forecast information after the first point on the prediction target item is greater than the inventory information on the prediction target item by a pre-set value or more. In addition, the electronic device 100 may identify as an under-forecasted state when the demand forecast information after the first point on the prediction target item is smaller than the inventory information on the prediction target item by a pre-set value or more.

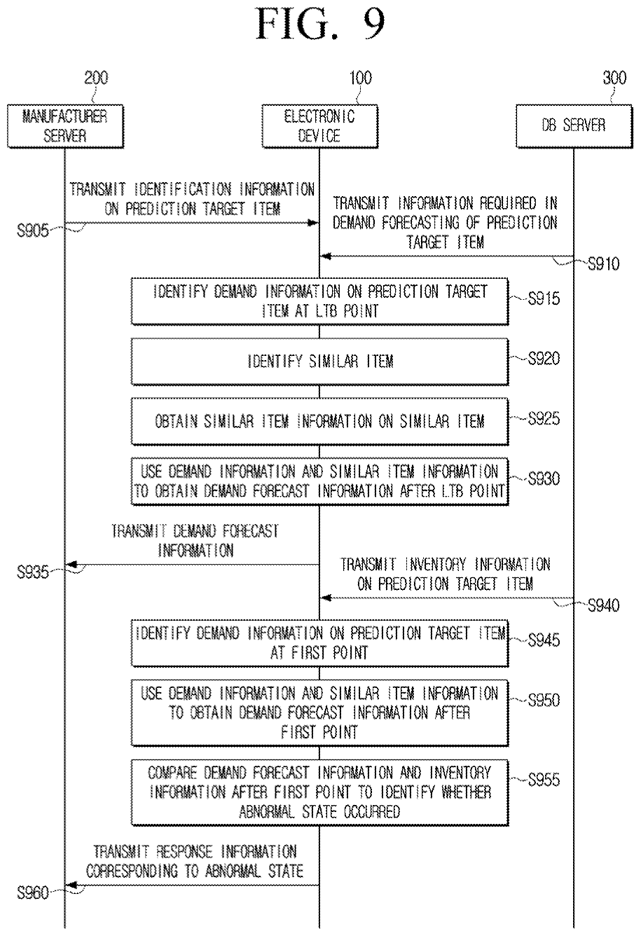

FIG. 9 is a sequence diagram showing an interaction between an electronic device 100, a manufacturer server 200, and a DB server 300 according to an embodiment.

According to an embodiment, in order to obtain demand forecast information after the LTB point of the prediction target item, the manufacturer server 200 may be configured to transmit identification information on the prediction target item to the electronic device 100 (S905), and the DB server 300 may be configured to transmit information required in demand forecasting of the prediction target item to the electronic device 100 (S910).

Based on the electronic device 100 receiving identification information on the prediction target item and information required in demand forecasting of the prediction target item, the electronic device 100 may use the identification information on the prediction target item and the information required in demand forecasting of the prediction target item to identify the demand information on the prediction target item at the LTB point (S915). The demand information of the prediction target item at the LTB point may include a production period of the prediction target item prior to the LTB point, a total amount in production with respect to the prediction target item, a service period, a total amount of service, a monthly production performance, a service performance zone, a defect generation rate, and the like, and may further include other, information which has high relevance with the demand information of the prediction target item.

The electronic device 100 may identify at least one similar item which has similar service demand characteristics with the prediction target item (S920). Specifically, the electronic device 100 may use information required for demand forecasting of the prediction target item to identify at least one similar item estimated to be similar in service demand characteristics with the prediction target item from among the plurality of items. In an embodiment, the electronic device may identify at least one similar item through the K-means clustering model.

Based on at least one similar item being identified, the electronic device 100 may obtain similar item information on the similar item (S925). The similar item information may include the demand information which has a high relevance with the service demand of the similar item and the actual demand information on the similar item.

Then, the electronic device 100 may use the demand information on the prediction target item and the similar item information to obtain the demand forecast information after the LTB point (S930). The demand forecast information after the LTB point may be information on the total amount in service demand on the corresponding prediction target item required after the LTB point. Specifically, the electronic device 100 may use the similar item information to generate the demand forecast model, and input first demand information to the generated demand forecast model to obtain demand forecast information after the LTB point on the prediction target item. In an embodiment, the demand forecast model may set be a model generated by setting the demand information which has high relevance with the service demand of the similar item as the input variable, and setting the actual demand information on the similar item as a dependent variable.

Based on the demand forecast information after the LTB point on the prediction target item being obtained, the electronic device 100 may transmit the demand forecast information to the manufacturer server 200 (S935). Then, the manufacturer server 200 may, based on the demand forecast information received from the electronic device 100, request an addition production of the forecasted prediction target item by the total amount in service demand to the component producing company.

Then, the electronic device 100 may check the inventory state of the prediction target item in real-time after the LTB point, and identify an abnormal state in inventory on the prediction target item.

Specifically, the DB server 300 may be configured to transmit inventory information on the prediction target item to the electronic device 100 (S940). In an embodiment, the DB server 300 may be configured to transmit current inventory information on the prediction target item to the electronic device 100 based on a pre-set time interval (e.g., 1 week).

The electronic device 100 may identify demand information on the prediction target item at the first point (S945). The demand information of the prediction target item at the first point may include a production period of the prediction target item prior to the LTB point, a total amount in production with respect to the prediction target item prior to the first point, a service period, a total amount of service, a monthly production performance, a service performance zone, a defect generation rate, and the like, and may further include other, information which has high relevance with the demand information of the prediction target item at the first point.

Then, the electronic device 100 may use the demand information on the prediction target item at the first point and the similar item information to obtain the demand forecast information after the first point (S950). Here, the similar item information may be information obtained at step S925, but is not limited thereto, and may be similar item information on a similar item newly generated at the first point.

Then, the electronic device 100 may compare the demand forecast information after the first point and the inventory information to identify whether an abnormal state has occurred (S955). In an embodiment, based on the demand forecast information after the first point on the prediction target item and the inventory information on the prediction target item being different by a pre-set value or more, the electronic device 100 may identify that an abnormal state has occurred at the first point.

Based on identifying that an abnormal state has occurred, the electronic device 100 may identify response information appropriate to the corresponding state from among the plurality of response information on the abnormal state. The response information on the over-forecasted state may include response information which may deplete the prediction target item at a low cost. For example, the response information on the over-forecasted state may include a request for terminating production of prediction target item, a request for transmitting and reviewing a list of compatible items, a request for transmitting and reviewing a list of companies capable of selling the prediction target item, and the like.

The response information on the under-forecasted state may include response information which may secure the prediction target item at a low cost. For example, the response information on the under-forecasted state may include a request for production rate improvement of the prediction target item, a request for transmitting and reviewing a list of compatible item materials, a request for production unit cost negotiation with the component producing company, and the like.

Then, the electronic device 100 may transmit the response information corresponding to the abnormal state to the manufacturer server 200 (S960).

Various modifications may be made to one or more embodiments of the disclosure and because the disclosure may include one or more embodiments, specific example embodiments have been illustrated in the drawings and described in detail in the description. However, it should be noted that the various embodiments are not for limiting the scope of the disclosure to a specific embodiment, and should be interpreted to include all modifications, equivalents and/or alternatives of the embodiments. In describing the drawings, like reference numerals may be used to refer to like elements.

In describing the disclosure, based on determining that the detailed description of the related known technologies may confuse the gist of the disclosure, the detailed description thereof may be omitted.

Further, the above-described example embodiments may be changed to various different forms, and the scope of technical spirit of the disclosure is not limited to the example embodiments described herein. Rather, the example embodiments are provided to augment the disclosure, and fully convey the technical spirit of the disclosure to one of ordinary skill in the art.

The embodiments described in the disclosure may be implemented in a recordable medium which is readable by a computer or a device similar to the computer using software, hardware, or the combination of software and hardware. By hardware implementation, the embodiments of the disclosure may be implemented using at least one from among application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, embodiments described herein may be implemented by the processor itself. By software implementation, embodiments such as the procedures and functions described herein may be implemented with separate software modules. Each of the above-described software modules may perform one or more of the functions and operations described in the disclosure.

The above-described method according to one or more embodiments of the disclosure may be stored in a non-transitory computer-readable medium. The non-transitory computer-readable medium may be mounted to various devices and used.

The non-transitory computer-readable medium may refer to a medium that stores data semi-permanently rather than storing data for a very short time, such as a register, a cache, a memory, or the like, and is readable by a machine. Specifically, programs for performing the above-described various methods may be stored in the non-transitory computer-readable medium such as, for example, and without limitation, a compact disc (CD), a digital versatile disc (DVD), a hard disc, a Blu-ray disc, a universal serial bus (USB), a memory card, a ROM, and the like.

According to an embodiment, the method according to one or more embodiments may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product may be at least stored temporarily in a storage medium such as a server of a manufacturer, a server of an application store, or a memory of a relay server, or temporarily generated.

While the disclosure has been illustrated and described with reference to example embodiments thereof, it will be understood that the example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A control method of an electronic device, the control method comprising:
obtaining first demand information related to a service demand of a prediction target item at a first time point, the first time point being after a Last-time Buy (LTB) point of the prediction target item;
obtaining inventory information on the prediction target item at the first time point;
identifying at least one similar item based on a comparison between service demand characteristics of the at least one similar item and service demand characteristics of the prediction target item;
obtaining similar item information related to a service demand of the identified at least one similar item;
obtaining demand forecast information after the first time point on the prediction target item based on the first demand information and the similar item information; and
identifying whether an abnormal state has occurred at the first time point by comparing the demand forecast information after the first time point and the inventory information.

2. The control method of claim 1, wherein the obtaining the demand forecast information comprises:
generating a demand forecast model based on the similar item information; and
obtaining the demand forecast information by inputting the first demand information to the generated demand forecast model.

3. The control method of claim 2, wherein the similar item information comprises second demand information corresponding to a service demand of the at least one similar item at the first point and demand information on the at least one similar item after the first time point.

4. The control method of claim 3, wherein the demand forecast model comprises a decision tree model, and
wherein, based on using the second demand information as an input variable, the decision tree model is trained so that demand forecast information on the prediction target item is output as a dependent variable.

5. The control method of claim 1, wherein the at least one similar item is identified through a K-means clustering model, and
the at least one similar item belongs to a same cluster as the prediction target item in the K-means clustering model.

6. The control method of claim 1, wherein the identifying whether the abnormal state has occurred further comprises:
identifying, based on the demand forecast information after the first time point and the inventory information being different by a pre-set value or more, that the abnormal state has occurred.

7. The control method of claim 1, further comprising:
identifying, based on identifying that the abnormal state has occurred at the first time point, response information on the abnormal state; and
transmitting the identified response information to an external electronic device.

8. The control method of claim 1, further comprising:
obtaining, based on identifying that the abnormal state has not occurred at the first time point, third demand information related to a service demand of the prediction target item at a second time point, the second time point being after the first time point;
obtaining inventory information of the prediction target item at the second time point;
obtaining demand forecast information after the second time point on the prediction target item by using the third demand information and the similar item information; and
identifying whether the abnormal state has occurred by comparing the demand forecast information after the second time point and inventory information on the prediction target item at the second time point.

9. The control method of claim 2, wherein the demand forecast model comprises one from among an artificial neural network model, a logistic regression model, a support vector machine model, or a random forest and gradient boosting model.

10. The control method of claim 1, wherein the obtaining the inventory information comprises:
receiving identification information on the prediction target item and information for demand forecasting of the prediction target item from an external electronic device; and
identifying the first demand information based on the identification information on the prediction target item and information for demand forecasting of the prediction target item.

11. An electronic device comprising:
a memory comprising at least one instruction; and
a processor configured to execute the at least one instruction to:
obtain first demand information related to a service demand of a prediction target item at a first time point, the first time point being after a Last-time Buy (LTB) point of the prediction target item;
obtain inventory information on the prediction target item at the first time point,
identify at least one similar item based on a comparison between service demand characteristics of the at least one similar item and service demand characteristics of the prediction target item;
obtain similar item information related to a service demand of the identified at least one similar item,
obtain demand forecast information after the first time point on the prediction target item based on the first demand information and the similar item information, and
identify whether an abnormal state has occurred at the first time point by comparing the demand forecast information after the first time point and the inventory information.

12. The electronic device of claim 11, wherein the processor is further configured to generate a demand forecast model based on the similar item information, and
obtain the demand forecast information by inputting the first demand information into the generated demand forecast model.

13. The electronic device of claim 12, wherein the similar item information comprises second demand information corresponding to a service demand of the at least one similar item at the first time point and demand information on the at least one similar item after the first time point.

14. The electronic device of claim 13, wherein the demand forecast model comprises a decision tree model, and
wherein, based on using the second demand information as an input variable, the decision tree model is trained so that demand forecast information on the prediction target item is output as a dependent variable.

15. The electronic device of claim 11, wherein the at least one similar item is identified through a K-means clustering model, and
the at least one similar item belongs to a same cluster as the prediction target item in the K-means clustering model.

16. The electronic device of claim 11, wherein the processor is further configured to identify, based on the demand forecast information after the first time point and the inventory information being different by a pre-set value or more, that the abnormal state has occurred.

17. The electronic device of claim 11, wherein the processor is further configured to identify, based on identifying that the abnormal state has occurred at the first time point, response information on the abnormal state, and
transmit the identified response information to an external electronic device.

18. The electronic device of claim 11, wherein the processor is further configured to obtain, based on identifying that the abnormal state has not occurred at the first time point, third demand information related to a service demand of the prediction target item at a second time point, the second time point being after the first time point;
obtain inventory information of the prediction target item at the second time point,
obtain demand forecast information after the second time point on the prediction target item by using the third demand information and the similar item information, and
identify whether the abnormal state has occurred by comparing demand forecast information after the second time point and inventory information on the prediction target item at the second time point.

19. The electronic device of claim 12, wherein the demand forecast model comprises one from among an artificial neural network model, a logistic regression model, a support vector machine model, or a random forest and gradient boosting model.

20. The electronic device of claim 11, further comprising:
a communication interface comprising circuitry,
wherein the processor is further configured to control the communication interface to receive identification information on the prediction target item and information for demand forecasting of the prediction target item from an external device, and
identify the first demand information based on the identification information on the prediction target item and information for demand forecasting of the prediction target item.
